(19) United States
(12) Patent Application Publication
(10) Pub. No.: US 2007/0065616 A1
(43) Pub. Date: Mar. 22, 2007

(54) Fuel filler hose

(76) Inventor: Michael K. Fauble, Cadillac, MI (US)

Correspondence Address: MCGARRY BAIR PC, 171 MONROE AVENUE, N.W., SUITE 600, GRAND RAPIDS, MI, 49503, US

(21) Appl. No.: 10/511,013

(22) PCT Filed: Apr. 10, 2003
(86) PCT No.: PCT/US03/11130

§ 371 Date: Jun. 21, 2005

Related U.S. Application Data
(60) Provisional application No. 60/371,800, filed on Apr. 11, 2002.

(51) Int. Cl. B32B 27/32; B32B 1/08; B32B 27/30; B32B 25/04

(52) U.S. Cl. 428/36.91; 428/421; 428/339; 428/522; 428/521; 156/244.13

(57) ABSTRACT

A flexible tubular article for transport of volatile hydrocarbons permitting only negligible escape of such vapors comprises: (a) a relatively thin, inner layer of an elastomeric form of an FKM fluoropolymer, and (b) one of more relatively thin intermediate layer of a thermoplastic form of an THV fluoropolymer extruded in tubular form over the inner FKM layer, the FKM inner layer and the intermediate THV layers together having a transverse thickness sufficient to present a substantial barrier to volatile hydrocarbon escape, and (c) a durable outer layer of an elastomeric polymer bonded to the outside surface of the intermediate layer and being coextensive therewith. The intermediate layers having increasing amounts of fluorine content and at least on the intermediate layers comprises a THV grade 800.

### CROSS REFERENCE TO RELATED APPLICATIONS

This application is a claims the benefit of U.S. Provisional Application 60/371,800, filed Apr. 11, 2002, all of which is incorporated herein in its entirety.

### BACKGROUND OF THE INVENTION

1. Field of the Invention

This invention relates to hydrocarbon impermeable elastomeric tubes and hoses. In one of its aspects, the invention relates to a method for manufacturing hydrocarbon impermeable elastomeric tubes and hoses for use, for example, in automotive fuel filler hoses and automotive fuel tubes. In another of its aspects, the invention relates to laminated structures having flexibility, impact resistance and hydrocarbon impermeability suited for use as a fuel and/or vapor conducting hoses and tubes.

2. Description of the Related Art

It has been known in recent times to use a multilayered or laminated rubber structure serving as a fuel transporting hose for an automotive fuel feed line into a vehicle reservoir. The conduit wall may have three or more layers; a heat and gasoline-resistant inner tube; a gasoline impermeable barrier layer, an intermediate elastomeric tie layer; a weather-resistant outer tube and a reinforcing fiber matrix or layer interposed and integrated between the outer and intermediate tie layers. Even so, oxygenated fuel adversely affect a fuel hose life so that enhanced gasoline-resistant features are needed. The fluoropolymer FKM, a terpolymer of tetrafluoroethylene, hexafluoropropylene and vinylidene fluoride, hereinafter, respectively, TFE, HPF, and VF₂, has exhibited satisfactory performance characteristics as a fuel resistant material. See, for example, U.S. Pat. No. 5,093,166, issued Mar. 3, 1992. However, it has proved difficult to bond an FKM layer to other rubbers. Further, FKM layers are not by themselves sufficiently impermeable to hydrocarbon vapors to enable automobile manufacturers to meet the California Air Resources Board standards for automotive vehicle emissions for 2003 and beyond.

Thin layer THV, also a terpolymer of TFE, HFP, and VF₂, has been used as a hydrocarbon barrier lamina in tubular hoses. These hoses have been made by extruding molten THV to form a tube and crosshead extruding a suitable elastomeric material over the THV tube. The resulting tubular hose is heated to bond the THV layer to the elastomeric layer and to vulcanize the elastomeric layer.

As to the automotive fuel filler tubes, some are presently made of relatively thick-walled nylon or polyethylene plastic, which provides the desired resistance to the usual hydrocarbon fuels, like gasoline, diesel oil, and oxygenate additives, for example, ethanol. However, thick-walled plastic tubing does not have sufficient flexibility and impact resistance to withstand automobile collisions without fuel line rupture. Flexibility and resilience of the tubing is also required to route the tubing through a tortuous path in the vehicle.

Vapor management tubes which are used to recycle fuel vapors (for pollution control) must be resistant to the combustion vapors as well as the fuel itself. A typical tubular construction is cross-head extruded, formed tubing, which involves an inner core of THV500 plastic and an outer core of epichlorohydrin rubber. But with the currently used laminated fuel tubular conduits, there is still a persistent hydrocarbon pollution problem, due in part to the relatively high gas vapor permeability of presently used polymeric materials. In order to acceptably be used as fuel filler tubes, the materials used in these constructions must essentially block or markedly reduce unused HC vapor transmission to the environment from the fuel tank.

For example, the available THV500/ECO tubing has an HC permeation resistance rating of about 120 g/m² per day vapor loss measurement using ASTM Reference Fuel C, while the California Air Resources Board wants to reduce permeability emissions to about 0.5 g per day for the entire vehicle. To that end, the auto industry currently seeks to reduce permeability for the gasoline filler tube and other fuel lines, vapor lines and vent hoses essentially to zero, a goal that is addressed by the present invention.

The U.S. Pat. No. 5,320,888 discloses extruding a first layer of an FKM fluoropolymer into a tubular form and wrapping the tubular form with a second layer of a thermoplastic fluoropolymer. A third layer of polymer is extruded over the second layer.

Fauble, et al. in U.S. Pat. No. 5,941,286 discloses and claims a composite fuel and vapor barrier tube comprising a core layer of an FKM fluoroelastomer, exhibiting the properties of a rubber, a second layer of THV fluoroplastic exhibiting the properties of a thermoplastic layer, these layers being relatively thin layers, and an external layer of a rubbery polymer such as an epichlorohydrin polymer (ECO). Preferably, a acrylic binder layer is between the THV fluoroplastic layer and the external rubbery polymer layer. The THV fluoroplastic can be a THV 500, 400, 350 or 200 polymer grades sold by Dyneon LLC, a 3M Company. Fauble, et al. further disclose and claim a process for making the composite fuel and vapor barrier tube comprising the steps of coextruding the FKM and THV layers under pressure to mechanically bond these two layers together and then crosshead extruding the external rubbery polymer layer onto the THV layer. A primer or binder coating is preferably applied to the THV layer between the coextrusion and crosshead extrusion steps. During the extrusion process, the temperature of the FKM fluoroelastomer is maintained below about 300° F., preferably about 270° F., while the temperature of the THV fluoroplastic is maintained above 400° F., preferably about 450° F.

### SUMMARY OF THE INVENTION

According to the invention, a flexible tubular article for transport of volatile hydrocarbons permitting only negligible escape of such vapors comprises:

(a) a relatively thin, inner layer of an elastomeric form of an FKM fluoropolymer, and;

(b) a relatively thin intermediate layer of a thermoplastic form of an 800 grade THV fluoropolymer extruded in tubular form over the inner FKM layer, the FKM inner layer and the intermediate THV layer together having a transverse thickness sufficient to present a substantial barrier to volatile hydrocarbon escape, and

(c) a durable outer layer of an elastomeric polymer bonded to the outside surface of the intermediate layer and being coextensive therewith.

Preferably, the core layer of FKM includes a measurable amount of an electroconductive filler material, like carbon black, useful to confer the desired core layer with conductivity for discharge of static electricity.

In a preferred embodiment, a first tie layer, preferably a nitrile or acrylic compound, bonds the THV layer to the durable outer layer. Optionally a reinforcing layer is provided between the tie layer and the durable outer layer. In one embodiment, the elastomeric polymer of the outer layer is a CSM polymer. Further, other layers of higher fluorine content fluoroplastics can be bonded to the THV layer to increase the impermeability of the tubular article.

In still another embodiment of the invention, a one or more second tie layers bind the inner FKM inner layer to the THV 800 intermediate layer. The tie layer preferably is a THV 500G layer. THV compounds of somewhat lower TFE content can form one of more tie layers between the higher TFE content THV barrier layer and the inner FKM inner layer.

In yet another embodiment, a layer of FEP can be extruded over the THV 800 layer, or, over a layer of THV 500G and a tie layer can be used between the FEP layer and the durable outer layer.

The present laminated polymeric structures, when fabricated into fuel conduits, provide for bendability when forming is needed, permit some compression without rupture, and will also tolerate moderate elongation without rupture. The laminated sidewalls demonstrate very low hydrocarbon permeability, both as to liquids, like gasoline, and to hydrocarbon vapors. Conductivity of the laminate inner layer inhibits the build-up of static electricity in the fuel reservoir. Finally, this somewhat resilient laminated sidewall shows the ability to mechanically seal itself and elongate, in the event of sidewall breach incidental to a vehicle collision.

According to a further embodiment of the invention, a flexible tubular article for transport of volatile hydrocarbons permitting only negligible escape of such vapors comprises:

(a) a relatively thin, inner layer of an elastomeric form of an FKM fluoropolymer, and;

(b) a plurality of relatively thin intermediate layers of a thermoplastic form of a non-elastomeric form of a THV fluoropolymer, each with increasing amounts of TFE content, extruded in successive tubular layers over the inner FKM layer, the FKM inner layer and the intermediate THV layers, together having a transverse thickness and fluorine content sufficient to present an effective barrier to volatile hydrocarbon escape through the walls of the tubular article, and

(c) a durable outer layer of an elastomeric polymer bonded to the outside surface of the outermost of the intermediate layers and being coextensive therewith.

The thickness of the various layers can vary over a wide range. Typically, the thickness of the FKM inner layer ranges from about 0.010 to 0.080 in (0.25 to 2 mm). The thickness of each of the intermediate layer or layers is relatively thin and ranges from about 0.001 to 0.020 in (0.025 to 0.5 mm). The thickness of the elastomeric polymer layer ranges from about 0.075-0.150 in. (2 to 4 mm).

Still further according to the invention, a process for making a tubular article which is substantially impermeable to volatile hydrocarbons comprises the steps of:

(a) extruding a plurality of relatively thin intermediate layers of a thermoplastic form of an THV fluoropolymer, each with increasing amounts of TFE content, over an inner elastomeric FKM layer in a tubular shape; and

(b) extruding onto the tubular shape a durable outer layer of a second elastomeric polymer to form a composite tubular article.

In one embodiment, the process further comprises the step of applying to the tubular shape a binder or tie layer to bond the outermost of the THV fluoropolymer layers to the elastomeric polymer prior to the extruding step (b). Preferably, the binder or tie layer comprises a nitrile or acrylic compound.

During the extrusion process, the temperature of the FKM fluoroelastomer is maintained below about 300° F., preferably about 240° F., while the temperature of the THV fluoroplastic is maintained above 400° F., preferably about 450°-550° F.

In a preferred embodiment of the invention, each of the intermediate layers has a thickness in the range of about 0.001 to 0.020 in (0.025 to 0.5 mm). The thickness of the elastomeric polymer layer ranges from about 0.075-0.150 in. (2 to 4 mm). Preferably, at least one of the intermediate layers is THV 800. At least another one of the intermediate layers is THV 500G.

In another embodiment of the invention, the process further comprises the steps of cutting the composite tubular article to lengths, partially curing the composite tubular article in straight condition to cross-link at least the elastomeric polymer layer to the grade 800 THV fluoroplastic polymer, shaping the partially cured composite article and fully curing the shaped composite article.

In yet another embodiment of the process according to the invention, a reinforcing layer is formed on the tie layer between the extruding and crosshead extruding steps.

In one embodiment, the extruding step comprises extruding one or more of the intermediate THV fluoroplastic layers over the inner elastomeric FKM layer.

The aspects and advantages of the present invention will be better understood by reference to the detailed description of preferred embodiments and associated features but the invention is not intended to be limited thereto.

### BRIEF DESCRIPTION OF THE DRAWINGS

In the drawings:

FIG. 1 is a perspective end view of a laminated tube according to the invention;

FIG. 2 is a sectional view of the laminated tube shown in FIG. 1, taken along lines 2-2 of FIG. 1;

FIG. 3 is a schematic representation of a process according to the invention for making the tube shown in FIGS. 1 and 2; and

### DESCRIPTION OF THE PREFERRED EMBODIMENT

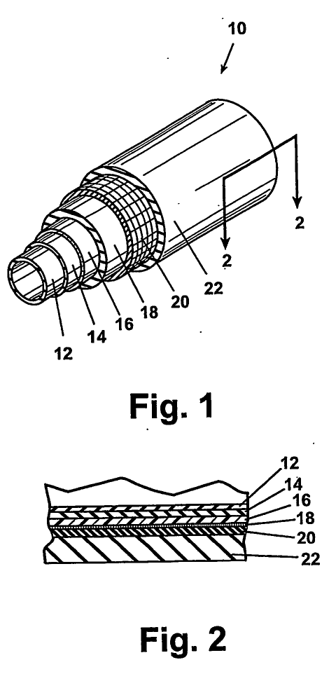

Referring now to the drawings, and to FIGS. 1 and 2 in particular, there is shown a flexible tubular article 10 for transporting volatile hydrocarbons according to the invention. Preferably, the article 10 is used as an automotive fuel filler tube for gasoline and has a high degree of permeability. The article 10 has inner layer 12 of an FKM fluoropolymer, an intermediate layer 16 of a 800 grade THV fluoropolymer, a binder layer 14 between the inner layer 12 and the intermediate layer 16 to bind the two layers together, a relatively thick layer 22 of a tough, durable elastomer and a thin binder layer 18 between the THV layer 16 and the elastomer layer 22 to bind these layers together. An optional reinforcing layer 20 can be placed between the binder layer 18 and the elastomer layer 22. The binder layer 14 is preferably one or more thin layers of a THV flouropolymer of lower grade than the intermediate layer 16. For example, the binder layer 14 can be a 500G THV or a combination of a 500G THV layer and a 200G THV layer between the intermediate layer 16 and the inner layer 12 with the 500G THV layer in contact with the intermediate layer 16 and the 200G THV layer in contact with the inner layer 12.

The FKM fluoropolymers which can be used according to the invention have been available for some time. For example, the FLUOREL brand of fluoroelastomers, introduced by the 3M Company of Minnesota in the early 1960s, are suitable for use in this invention. These fluoroelastomers are TFE/HFP/VF_{.2} terpolymeric compositions, which are melt processable fluoro-plastics, providing a useful combination of performance and processing advantages without the need for organic additives. They are characterized by low processing temperature range (100° C. to 175° C.), co-processability with temperature-sensitive substrates, like non-fluorinated plastics, and elastomers, like ECO. They also are essentially amorphous and have the characteristics of elastomers, i.e., they are thermosetting compounds that exhibit a 100% stretch without deformation. Typically, the fluoroelastomers contain about 65-71% fluorine by weight. They also show excellent flexibility/elongation features with low flexural modulus, good flex fatigue life, and avoidance of stress cracking. They evince versatile bondability (hot melt adhesive) and a broad temperature service range.

These fluoroelastomers can have a relatively wide range of monomer ratios. These fluoroelastomers are generally described in U.S. Pat. No. 2,833,752, issued May 5, 1958 and U.S. Pat. No. 5,208,305, issued May 4, 1993, both of which patents are incorporated herein by reference. Generally, the TFE component can be present in the range of 0 to 70 weight parts, the HFP component can have a range of 20 to 50 weight parts and the VF₂ component can have a range of 20 to 80, based on 100 weight parts of FKM. A suitable fluoroelastomer is a fluoroelastomer sold by Dyneon LLC, a 3M Company under the designation FE5830Q. This polymer has about 33% VF₂, 24% TFE and 43% HFP, by weight.

Suitable FKM polymers are obtained, for example, by polymerizing a mixture of monomers consisting of 40 mol percent of TFE, 30 mol percent of HFP and 30 mol percent of VF₂, with the monomer mixture also containing up to 5 weight parts of a bisphenol cross-linking agent per 100 parts, by weight, of the three monomers and 1-20 parts of a basic metal oxide. This FKM composition is suited to a well-known extrusion process for forming the FKM layer 14.

The FKM polymer is compounded with various additives, such as carbon black, cross-linking agents and plasticizers for processability and for conductivity. FKM layer 12 is preferably conductive, as the result of additives such as carbon black. Other compounding ingredients include magnesium oxide, calcium hydroxide and carnauba wax.

The THV fluoropolymers used in the intermediate layer 16 and in the one or more tie layer(s) 14 of the invention are fluoroplastic terpolymers which comprise the following polymerized units: (a) 1-50% by weight of VF₂; (b) 35-80% by weight of TFE; and (c) 10-30% by weight of HFP, with the proviso that the quantities of VF₂, TFE and HFP make up 100% by weight of the polymer component of the THV layer. The THV fluoroplastic polymer used in the invention is used without any further adjuvant compounds.

The THV fluoropolymers used in the intermediate layer 16 and the tie layer or layers 14 should be partially crystalline, that is, they should contain 10 to 70% by weight of crystalline components and have a crystalline melting point of 100-240° C., measured by differential thermal analysis. Polymers having a melting point of below 100° C. are generally too soft for the intended application. Polymers having a melting point above 240° C. are more difficult to process in the intended application. THV 800 fluoroplastic sold by Dyneon LLC, a 3M Company, is the preferred compound used in the barrier intermediate layer 16 of the invention. This THV fluoropolymer has a melting point of 203° C. and a density of 2.0. These fluoropolymers are thermoplastic in nature, i.e., they melt when heated and are subject to elastic deformation at 100% elongation. The THV tie layer or layers 14 are preferably of lower grade, i.e., with lower amounts of TFE. These THV fluoropolymers are generally described in U.S. Pat. No. 5,055,539, issued Oct. 8, 1991, which patent is incorporated herein by reference in its entirety.

The THV fluoroplastic polymers typically have specific gravity ranges from 1.95 to 1.98 g./cc ASTM 792), melting range from 115.degree. C. to 180.degree. C. (DSC), a melt flow index from 5-25 (265 C/5 kg.)(ASTM 1238) in powder and pellet form and 35-60 (265 C/5 kg.) (ASTM 1238) in aqueous dispersions. THVs have a tensile stress at break of 20 N/mm (ASTM 638) and elongation at break 500-600 percent (ASTM 638), a limiting oxygen index of 75 (ASTM 2863) and flammability rating of V0 (UL 94).

The employment of THV 800 fluoroplastic, in the form of granules (pelleted is the preferred material), is suitable for melt processing into a extruded formed article with FKM polymers. The lower melting point of the THV polymers provides for a more complete and uniform fusing of the THV to itself and to the adjacent FKM polymer layer.

The THV fluoroplastic polymers have the advantage of being an easily extrudable material that is flexible and crystalline. Further, they are bondable to the other substrates and have relatively low temperature processability. They have relatively high elongation properties.

The elastomeric compound should have one or more of the following properties: ozone and weather resistance, moderate fuel resistance, flame resistance and it must adhere to the fluoroplastic polymer. The elastomeric compound used as layer 22 can be selected from various vulcanizable elastomeric compounds of any known natural rubber or synthetic rubber stock and including, without limitation, epichlorohydrin elastomers including ECO copolymer and terpolymer, styrene-butadiene rubber (SBR), of both high and low durometer grades and oil-extended types; neoprene (G and W types); ethylene-propylene copolymer and terpolymer rubbers; butyl rubber; acrylonitrile-butadiene rubber; chlorosulfonated polyethylene rubber; chlorinated polyethylene; ethylene acrylic rubber; polyacrylate rubber; and NBR/PVC. Preferably, the elastomeric compound is a chlorosulfonated polyethylene or chlorinated polyethylene polymer. The elastomeric rubber is compounded with the usual compounding ingredients, such as cross-linking agents, carbon black, plasticizers, and the like.

The tie layer 18 can be any suitable binder material to promote the adhesion of the THV layer 16 to the elastomer layer 22. Preferably these compounds are nitrile rubber or acrylic compounds such as ethylene acrylic rubber.

The tie layer 14 can be any suitable material that binds the FKM layer to the THV 800 layer 16. Suitable binders are lower TFE content THV materials, for example, 500G THV, sold by Dyneon LLC, a 3M Company. The tie layer 14 can be formed by multiple layers of THV thermoplastic compounds with increasingly higher TFE content.

The thickness of the FKM layer 12 can vary somewhat but is generally kept relatively thin. Generally, the FKM layer 12 has a thickness in the range of about 0.01 to 0.040 in. (0.25 to 1 mm), preferably in the range of 0.020 to 0.030 in. (0.5 to 0.75 mm).

The THV 800 layer 16 can also vary widely but is selected to give the appropriate barrier to hydrocarbons in conjunction with the FKM layer 12 and the tie layer 14. Generally, the THV 800 layer will be in the range of 0.10 to 0.50 mm, preferably in the range of 0.20 to 0.25 mm.

The elastomer layer 22 is relatively thick, and forms the bulk of the tubing wall. The thickness of the elastomeric layer 22 can vary over a wide range but typically will fall in the range of 1.5 to 5.0 mm thick, preferably in the range of 0.075-0.150 in. (2.0 to 4 mm). The tie layer or layers 14 are relatively thin, and will generally have a thickness in the nature of about 0.020 to 0.060 inches (0.5 to 1.5 mm). The tie layers 14 and 20 can be applied to the FKM and THV 800 layers, respectively, in a variety of methods that include wrapping and extrusion.

The optional reinforcing layer can be any type of woven or knit fabric layers and are well known in the reinforced rubber hose field.

In one embodiment of the invention, an intermediate or further layer of FEP can be extruded over the inner FKM layer with multiple tie layers of THV with increasing amounts of TFE therebetween. In this embodiment, one or more layers of THV of decreasing amounts of TFE can be used as one or more tie layers between the FEP layer and the durable outer layer 22 or reinforcing layer 20.

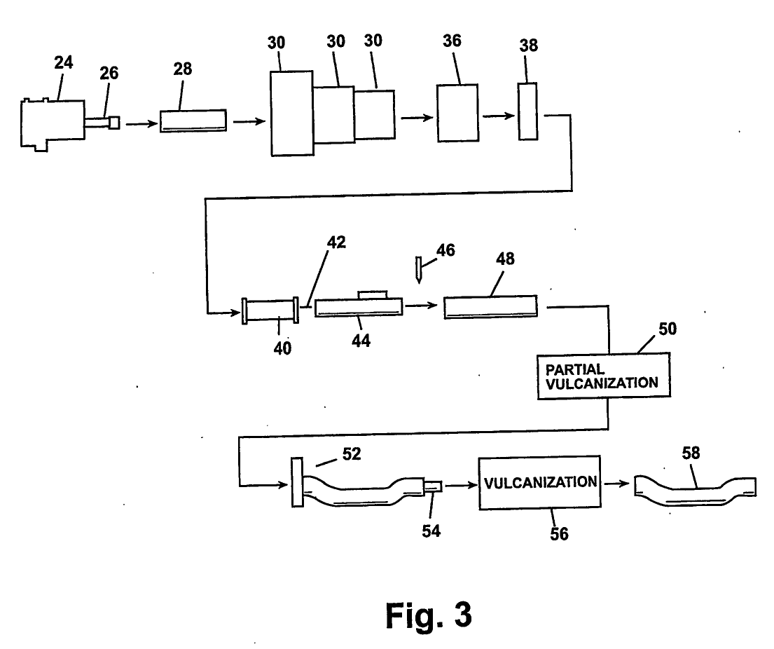

Referring now to FIG. 3, there is shown in schematic form a process for producing tubing according to the invention. A rubber extruder 24 has an extrusion die 26 to extrude a FKM tubing. The extruded tubing is passed through a cooler 28 and then passed through a multi-layer plastic cross head extruder with multiple extruders 30 that extrude simultaneously multiple layers of THV thermoplastic onto the FKM tubing. Each successive layer has an increased amount of TFE content. The multi-layer tubing then is passed through a rubber extruder 36 that applies a tie layer of nitrile rubber onto the outer surface of the multi-layer tubing. The thus tie layer coated tubing is then passed through another cross head extruder 38 at which is applied an exterior layer of an elastomeric material. The extruder 24 heats the FKM to a suitable processing temperatures and extrudes the FKM under pressure through the extrusion die 26. The temperature of the THV is kept above about 400° F., preferably about 450° F., while the temperature of the FKM is kept below 300° F., preferably about 240° F., during the extrusion processes. The rubber extruder heats the elastomeric compound to a processing temperature at which it can be extruded onto the coated tubing 32. A puller 40 pulls the composite tubing 42 from the crosshead extruder 38. The tubing 42 is then cut to lengths 48 with a knife 46 in a well known operation. The length of tubing is given a relatively light vulcanization treatment in a vulcanization chamber 50 by heating the tubing lengths in straight condition to a temperature in the range of 250° F. to 350° F. for a period of about 5 to 30 minutes. This partial vulcanization step is carried out while the tubing is straight to cross-link the outer elastomer layer 22 to the THV fluoroplastic layer 16. The length of tubing 48 is then placed onto a shaping device 52, for example, having a mandrel 54 to give a shape to the tubing. The shaped tubing is then vulcanized in a vulcanizing oven 56 to vulcanize the elastomeric composition in the layer 22 as well as the FKM layer 12. The vulcanization takes place in a well known process. After vulcanization, the shaped and vulcanized tubing 58 is removed from the shaping device 52 and subsequently cooled.

The laminated resilient structure of this invention is adaptable to be formed into various shapes such as the tubular article of FIG. 1, shown after extrusion by the method of the invention, but seen prior to its shaping and vulcanization to adapt to a particular auto fuel filler or vapor management tube. The resulting resilient articles of variable lengths, and of differing configurations (due to the internal geometry of the autos), present an organic chemical and weather-resistant fluid conduit, permitting only negligible escape of volatile HC vapors, due to enhanced sidewall gas impermeability.

While the invention has been specifically described in connection with certain specific embodiments thereof, it is to be understood that this is by way of illustration and not of limitation. Reasonable variation and modification are possible within the scope of the forgoing disclosure and claims without departing from the spirit of the invention.

What is claimed is:

1. A flexible tubular article for transport of volatile hydrocarbons permitting only negligible escape of such vapors comprising:
(a) a relatively thin, inner layer of an elastomeric form of an FKM fluoropolymer, and;
(b) a relatively thin intermediate layer of a thermoplastic form of an 800 grade THV fluoropolymer extruded in tubular form over the inner FKM layer, the FKM inner layer and the intermediate THV layer together having a transverse thickness sufficient to present a barrier to volatile hydrocarbon escape, and
(c) a durable outer layer of an elastomeric polymer bonded to the outside surface of the intermediate layer and being coextensive therewith.

2. The article according to claim 1 wherein the thickness of the FKM inner layer ranges from about 0.010 to 0.080 in (0.25 to 2 mm).

3. The article according to claim 2 wherein the thickness of the THV intermediate layer ranges from about 0.001 to 0.020 in (0.025 to 0.5 mm).

4. The article according to claim 3 wherein the thickness of the elastomeric polymer outer layer ranges from about 0.075-0.150 in. (2 to 4 mm).

5. The article according to claim 4 wherein the elastomeric polymer is selected from the group consisting of chlorinated polyethylene, ECO, ethylene acrylic, polyacrylate, NBR/PVC, chlorosulfonated polyethylene and mixtures thereof.

6. The article according to claim 1 and further comprising a first tie layer between the intermediate and elastomeric polymer layers.

7. The article according to claim 6 wherein the first tie layer comprises a nitrile rubber or an ethylene acrylic rubber compound.

8. The article according to any claim 1 and further comprising a second tie layer between the inner FKM inner layer to the THV 800 intermediate layer to bind the two layers together.

9. The article according to claim 8 wherein the second tie layer is a THV 500G compound.

10. The article according to claim 1 wherein the thickness of the intermediate THV layer ranges from about 0.001 to 0.020 inches (0.025 to 0.50 mm).

11. The article according to claim 1 wherein one or more thermoplastic THV tie layers of increasing TFE content bind the inner FKM inner layer to the THV 800 intermediate layer.

12. The article according to claim 1 wherein the thickness of the elastomeric polymer layer ranges from about 0.075-0.150 in. (2 to 4 mm) and the elastomeric polymer is selected from the group consisting of chlorinated polyethylene, ECO, ethylene acrylic, polyacrylate, NBR/PVC, chlorosulfonated polyethylene and mixtures thereof.

13. The article according to claim 1 wherein the inner layer is conductive.

14. The article according to claim 1 and further comprising a reinforcing layer between the intermediate THV layer and the outer layer.

15. A process for making a tubular article which is substantially impermeable to volatile hydrocarbons, said process comprising the steps:
(a) extruding a plurality of relatively thin intermediate layers of a thermoplastic form of an THV fluoropolymer, each with increasing amounts of fluorine content, over an inner elastomeric FKM layer in a tubular shape; and
(b) crosshead extruding onto the tubular shape a durable outer layer of a second elastomeric polymer to form a composite tubular article.

16. A process according to claim 15 and further comprising the step of applying to the tubular shape a binder to bond the 800 THV fluoropolymer to the elastomeric polymer prior to the crosshead extruding step.

17. A process according to claim 16 wherein the binder comprises a nitrile rubber or an ethylene acrylic rubber compound.

18. The process according to claim 15 wherein the thickness of the first elastomeric polymer layer is in the range of about 0.010 to 0.080 in (0.25 to 2 mm).

19. The process of claim 18 wherein the thickness of each of the intermediate layer or layers is relatively thin and ranges from about 0.001 to 0.020 inches (0.025 to 0.50 mm).

20. The process of claim 19 wherein the thickness of the elastomeric polymer layer is in the range of about 0.075-0.150 in. (2 to 4 mm).

21. A process according to claim 15 and further comprising the steps of cutting the composite tubular article to lengths, partially curing the composite tubular article in straight condition to cross-link at least the elastomeric polymer layer to the grade 800 THV fluoroplastic polymer, shaping the partially cured composite article and fully curing the shaped composite article.

22. The process for making a tubular article according to claim 15 and further comprising the step of forming a reinforcing layer on the binder layer between the extruding and crosshead extruding steps.

23. A flexible tubular article for the transport of volatile hydrocarbon vapors and vaporous combustion products and permitting only negligible escape of such vapors comprising:
(a) a relatively thin, inner layer of an elastomeric form of an FKM fluoropolymer;
(b) a plurality of relatively thin intermediate layers of a thermoplastic form of a non-elastomeric form of a THV fluoropolymer, each with increasing amounts of TFE content, extruded in successive tubular layers over the inner FKM layer, the FKM inner layer and the intermediate THV layers, together having a transverse thickness and fluorine content sufficient to present an effective barrier to volatile hydrocarbon escape through the walls of the tubular article, and
c) a durable outer layer of an elastomeric polymer bonded to the outside surface of the outermost of the intermediate layers and being coextensive therewith.

24. The article of claim 23 and further comprising a binder layer between the intermediate THV layers and the durable outer layer.

25. The article of claim 24 wherein the binder layer comprises a nitrile or ethylene oxide rubber compound and the elastomeric polymer is selected from the group consisting of chlorinated polyethylene, ECO, ethylene acrylic, polyacrylate, NBR/PVC, chlorosulfonated polyethylene and mixtures thereof.

26. The flexible tubular article according to claim 23 and further comprising a reinforcing layer between the tubular intermediate layers of THV fluoropolymer and the durable outer layer.
